(19) United States
(12) Patent Application Publication
(10) Pub. No.: US 2025/0174390 A1
(43) Pub. Date: May 29, 2025

(54) MAGNETIC ELEMENT

(71) Applicant: LITE-ON TECHNOLOGY CORPORATION, Taipei (TW)

(72) Inventors: Chun-Yi CHANG, Taipei (TW); Cheng-Ting Chang, Taipei (TW)

(21) Appl. No.: 18/586,610

(22) Filed: Feb. 26, 2024

(30) Foreign Application Priority Data
Nov. 24, 2023 (CN) 202311582055.3

(51) Int. Cl. H01F 27/24; H01F 27/30

(52) U.S. Cl. CPC H01F 27/24; H01F 27/306

(57) ABSTRACT

A magnetic element includes a first, a second magnetic cores and a coil set. The first magnetic core includes a first, a second flank posts and a first side pillar. The first side pillar has a first joint surface. The first and second flank posts, respectively having a second and a third joint surfaces, and the first side pillar form an accommodation space in which the second magnetic core is disposed. The second magnetic core includes a second side pillar, a first and a second end posts. A first, a second, a third and a fourth air gaps are respectively formed between the first end post and second joint surfaces, between the second end post and third joint surfaces, between the first end post and the first joint surface, and between the second end post and the first joint surface. The coil set surrounds the second side pillar.

This application claims the benefit of People's Republic of China patent application Serial No. 202311582055.3, filed Nov. 24, 2023, the subject matter of which is incorporated herein by reference.

### BACKGROUND OF THE INVENTION

### Field of the Invention

The invention relates in general to a magnetic element, and more particularly to a magnetic element whose efficiency can be adjusted according to design needs.

### Description of the Related Art

Magnetic components such as transformers and inductors are often used in various devices such as power supplier. It has become a prominent task for the industry to provide a magnetic element whose efficiency can be adjusted according to design needs.

### SUMMARY OF THE INVENTION

The present invention relates to a magnetic element, which has several air gaps formed between two magnetic cores for adjusting the efficiency of the magnetic element according to design needs.

According to a first embodiment of the present invention, a magnetic element is provided. The magnetic element includes a first magnetic core, a second magnetic core and a coil set. The first magnetic core includes a first flank post, a second flank post and a first side pillar. The first side pillar has a first joint surface. The first flank post and the second flank post are disposed on the first joint surface of the first side pillar; the first flank post, the second flank post and the first side pillar form an accommodation space. The first flank post and the second flank post have a second joint surface and a third joint surface, respectively, in a face-to-face configuration. The second magnetic core is disposed in the accommodation space. The second magnetic core includes a second side pillar, a first end post and a second end post. The first end post and the second end post are disposed at two ends of the second side pillar, respectively. A first air gap, a second air gap, a third air gap and a fourth air gap are formed between the first end post and the second joint surface, between the second end post and the third joint surface, between the first end post and the first joint surface, and between the second end post and the first joint surface, respectively. The coil set surrounds the second side pillar.

The above and other aspects of the invention will become better understood with regard to the following detailed description of the preferred but non-limiting embodiment(s). The following description is made with reference to the accompanying drawings.

### BRIEF DESCRIPTION OF THE DRAWINGS

FIG. 1 is an assembly diagram of a magnetic element according to an embodiment of the present invention;

FIG. 2 is an explosion diagram of the magnetic element of FIG. 1;

FIG. 3A is a schematic diagram of a first magnetic core of the magnetic element of FIG. 1;

FIG. 3B is a schematic diagram of the first magnetic core of FIG. 3A viewed from another view angle;

FIG. 4A is a schematic diagram of a second magnetic core of the magnetic element of FIG. 1;

FIG. 4B is a schematic diagram of the second magnetic core of FIG. 4A viewed from another view angle;

FIG. 5 is a three-dimensional cross-sectional view of the magnetic element of FIG. 1;

FIG. 6 is a cross-sectional view of the magnetic element of FIG. 1;

FIG. 7 is a cross-sectional view of a magnetic element according to another embodiment of the present invention;

FIG. 8 is a side view of a magnetic element according to an alternative embodiment of the present invention;

FIG. 9 is a side view of a magnetic element according to another alternative embodiment of the present invention;

FIG. 10 is a diagram of inductance curves of a magnetic element of a comparison example and embodiments of the present invention obtained under different loads of current;

FIG. 11 is an assembly diagram of a magnetic element according to other embodiment of the present invention;

FIG. 12A is a schematic diagram of a second magnetic core of the magnetic element of FIG. 11;

FIG. 12B is a schematic diagram of the second magnetic core of FIG. 12A viewed from another view angle; and

FIG. 13 is a cross-sectional view of the magnetic element of FIG. 11 along cross-sectional line 13-13′.

### DETAILED DESCRIPTION OF THE INVENTION

The magnetic element of the present invention includes a first magnetic core, a second magnetic core and a coil set. Several air gaps are formed between the first magnetic core and the second magnetic core. The air gaps can adjust the efficiency of the magnetic element according to design needs.

Detailed descriptions of each embodiment of the present invention are disclosed below with reference to accompanying drawings. Apart from the said detailed descriptions, any embodiments in which the present invention can be used as well as any substitutions, modifications or equivalent changes of the said embodiments are within the scope of the present invention, and the descriptions and definitions in the claims shall prevail. Many specific details and embodiments are disclosed in the specification for anyone ordinary skilled in the art to comprehensively understand the present invention, not for limiting the present invention. Moreover, generally known procedures or elements are not disclosed to avoid adding unnecessary restrictions to the present invention. Designations common to the accompanying drawings are used to indicate identical or similar elements.

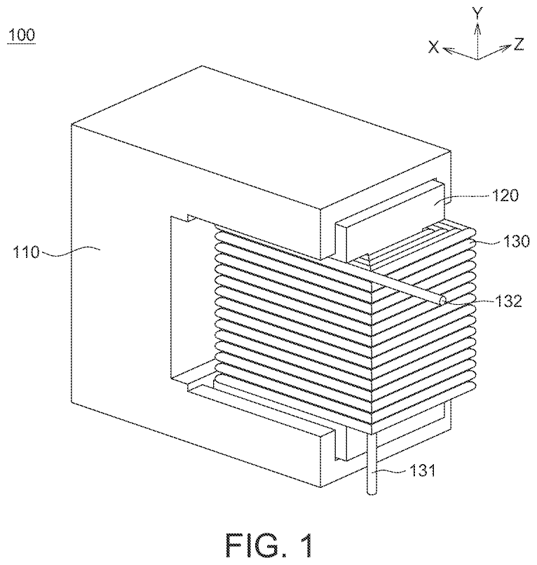

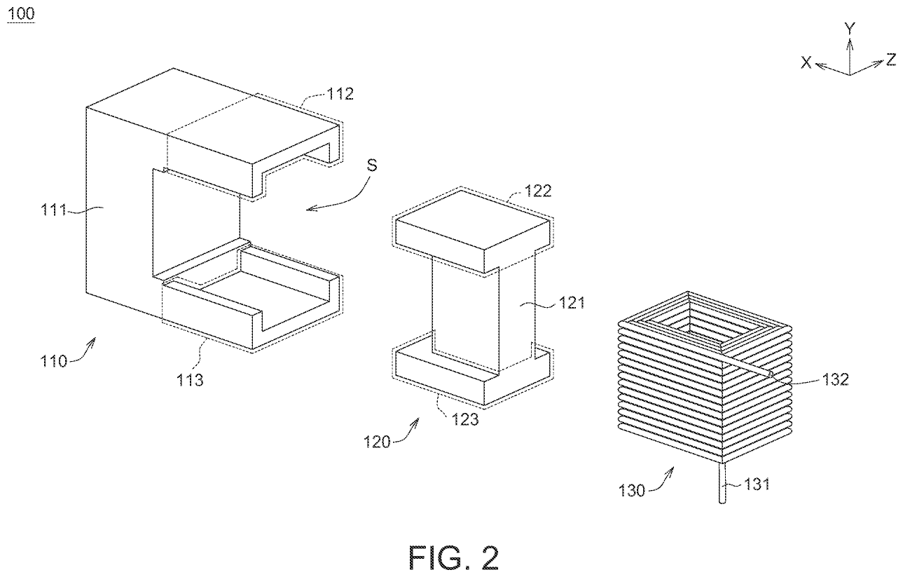

FIG. 1 is an assembly diagram of a magnetic element 100 according to an embodiment of the present invention. FIG. 2 is an explosion diagram of the magnetic element 100 of FIG. 1.

Refer to FIG. 1 and FIG. 2. The magnetic element 100 includes a first magnetic core 110, a second magnetic core 120 and a coil set 130. The first magnetic core 110 includes a first side pillar 111, a first flank post 112 and a second flank post 113. The first side pillar 111, the first flank post 112 and the second flank post 113 can be integrally formed in one piece. The first side pillar 111, the first flank post 112 and the second flank post 113 form an accommodation space S. The second magnetic core 120 includes a second side pillar 121, a first end post 122 and a second end post 123. The second side pillar 121, the first end post 122 and the second end post 123 can be integrally formed in one piece. The coil set 130 surrounds the second side pillar 121 of the second magnetic core 120. The second magnetic core 120 and the coil set 130 surrounding the second side pillar 121 can be disposed in the accommodation space S along a positive direction of the X axis. When the current flows through the coil set 130, the second magnetic core 120 and the first magnetic core 110 can form a closed magnetic circuit.

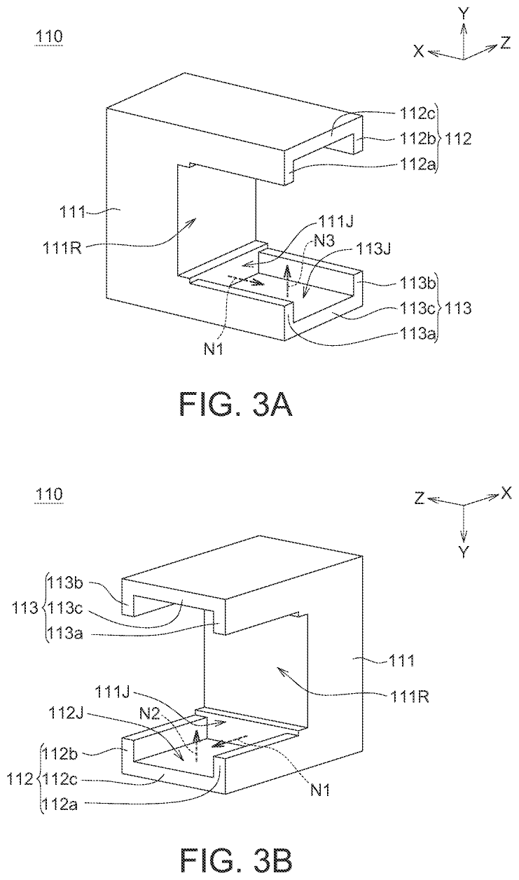

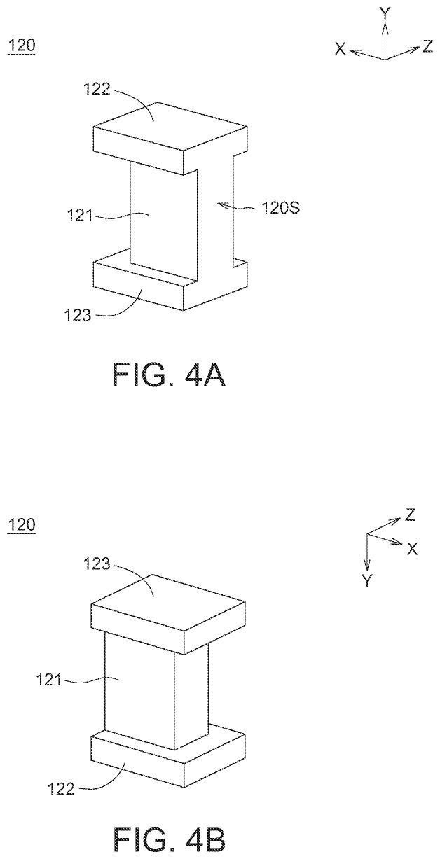

FIG. 3A is a schematic diagram of a first magnetic core 110 of the magnetic element 100 of FIG. 1. FIG. 3B is a schematic diagram of the first magnetic core 110 of FIG. 3A viewed from another view angle. FIG. 4A is a schematic diagram of a second magnetic core 120 of the magnetic element 100 of FIG. 1. FIG. 4B is a schematic diagram of the second magnetic core 120 of FIG. 4A viewed from another view angle.

Refer to FIG. 2, FIG. 3A and FIG. 3B. The first side pillar 111 of the first magnetic core 110 has a first joint surface 111J facing a negative direction of the X axis. In other words, the first joint surface 111J has a first normal line N1 parallel to the X axis and pointing towards a negative direction of the X axis. In a specific embodiment, the first side pillar 111 has a groove portion 111R, which is slightly recessed (towards a positive direction of the X axis) from roughly the center position of the first side pillar 111 along the Y axis, so that the first side pillar 111 basically forms a U-shaped structure.

The first flank post 112 and the second flank post 113 are disposed on the first joint surface 111J of the first side pillar 111. In a specific embodiment, the first flank post 112 and the second flank post 113 include first walls 112a and 113a, second walls 112b and 113b, and connection walls 112c and 113c, respectively. The connection walls 112c and 113c connect the first walls 112a and 113a and the second walls 112b and 113b. The first wall 112a and the second wall 112b are disposed on two opposite sides of the connection wall 112c on the Z axis, and the first wall 112a and the second wall 112b also extend towards a negative direction of the Y axis, so that the first wall 112a, the connection wall 112c and the second wall 112b form a U-shaped flank post. The first wall 113a and the second wall 113b are disposed on two opposite sides of the connection wall 113c on the Z axis and the first wall 113a and the second wall 113b also extend towards a positive direction of the Y axis, so that the first wall 113a, connection wall 113c and the second wall 113b form a U-shaped flank post. The second flank post 112 of the first magnetic core 110 has a second joint surface 112J; the second flank post 113 of the first magnetic core 110 has a third joint surface 113J. The second joint surface 112J faces a negative direction of the Y axis; the third joint surface 113J face a positive direction of the Y axis. The second joint surface 112J and the third joint surface 113J are in a face-to-face configuration. In other words, the second joint surface 112J has a second normal line N2; the third joint surface 113J has a third normal line N3. The second normal line N2 and the third normal line N3 are parallel to the Y axis and pointing towards a negative direction and a positive direction of the Y axis, respectively. In a specific embodiment, the second joint surface 112J can be the surface by which the connection wall 112c of the first flank post 112 faces the accommodation space S; the second joint surface 112J and the first joint surface 111J are interconnected. The third joint surface 113J can be the surface by which the connection wall 113c of the second flank post 113 faces the accommodation space S; the third joint surface 113J and the first joint surface 111J are interconnected.

In a specific embodiment, the first magnetic core 110 is basically a U-shaped magnetic core. In the first magnetic core 110, the first side pillar 111, the first flank post 112 and the second flank post 113 can respectively be a U-shaped structure, and the opening of each U-shaped structure faces the accommodation space S.

Refer to FIG. 2, FIG. 4A and FIG. 4B. The second side pillar 121 of the second magnetic core 120 is a cuboid structure extending along the Y axis. The first end post 122 and the second end post 123 are disposed at the two ends of the second side pillar 121, respectively, such as the two ends of the second side pillar 121 on the Y axis. In a specific embodiment, the second magnetic core 120 is basically an I-shaped magnetic core. The first end post 122 and the second end post 123 can be a flat structure, respectively; the first end post 122 and the second end post 123 are respectively perpendicular to the second side pillar 121.

The first end post 122 and the second end post 123 are protruded from the second side pillar 121 in a positive direction and a negative direction of the Z axis and a positive direction of the X axis, respectively; one side of the second magnetic core 120 facing a negative direction of the X axis has a flat surface 120S. Refer to FIG. 1, FIG. 2 and FIG. 4A. The coil set 130 has a coiling-in end 131 where coiling starts and a coiling-out end 132 where coiling finishes. The coiling-in end 131 of the coil set 130 can be disposed on the flat surface 120S, so that the coil feeds in via one side of the flat surface 120S and starts winding around the second side pillar 121 of the second magnetic core 120. The coil feeds in and starts winding via one side of the flat surface 120S. When the coil gradually winds around the second side pillar 121, the coil subsequently winding around the second side pillar 121 will not stack on or squeeze the coil at the coiling-in end 131, hence avoiding the risk of short circuiting, which would otherwise occur due to the abrasion of the coil at the coiling-in end 131. Besides, the coil can be automatically wound around the coil set 130 using a winder.

On the other hand, since the coil set 130 is exposed in a negative direction of the X axis, so that overall space of dissipation can be increased, and the dissipation efficiency can be improved.

The first magnetic core 110 and the second magnetic core 120 can be made of different materials. In an embodiment, the first magnetic core 110 can be made of a material with a larger vacuum permeability, so that the inductance at a light load can be increased. For instance, the first magnetic core 110 can be made of manganese zinc alloy, and the second magnetic core 120 can be made of iron-nickel alloy.

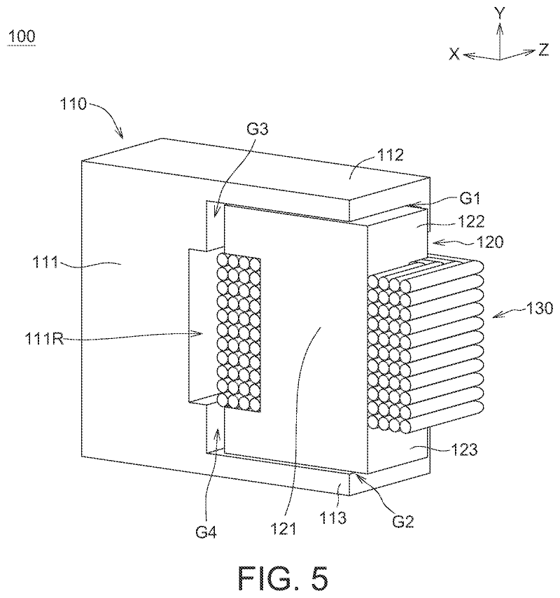

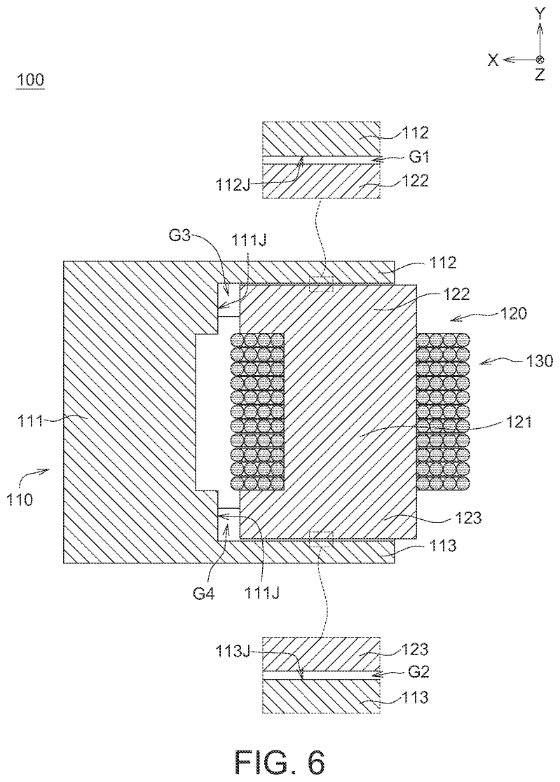

FIG. 5 is a three-dimensional cross-sectional view of the magnetic element 100 of FIG. 1. FIG. 6 is a cross-sectional view of the magnetic element 100 of FIG. 1.

Refer to FIG. 5 and FIG. 6. A first air gap G1 is formed between the first end post 122 of the second magnetic core 120 and the second joint surface 112J of the first flank post 112 of the first magnetic core 110; a second air gap G2 is formed between the second end post 123 of the second magnetic core 120 and the third joint surface 113J of the second flank post 113 of the first magnetic core 110. The first air gap G1 and the second air gap G2 are the distance between the first end post 122 and the second joint surface 112J and the distance between the second end post 123 and the third joint surface 113J on the Y axis, respectively. The size of the first air gap G1 and the size of the second air gap G2 can be adjusted according to the specification of the power supply used by the magnetic element 100. For instance, the size of the first air gap G1 and/or the size of the second air gap G2 can be increased to adjust the operating current needed by the magnetic element 100. The size of the first air gap G1 and the size of the second air gap G2 can be adjusted by changing the sizes/shapes of the first end post 122 and the second end post 123 of the second magnetic core 120.

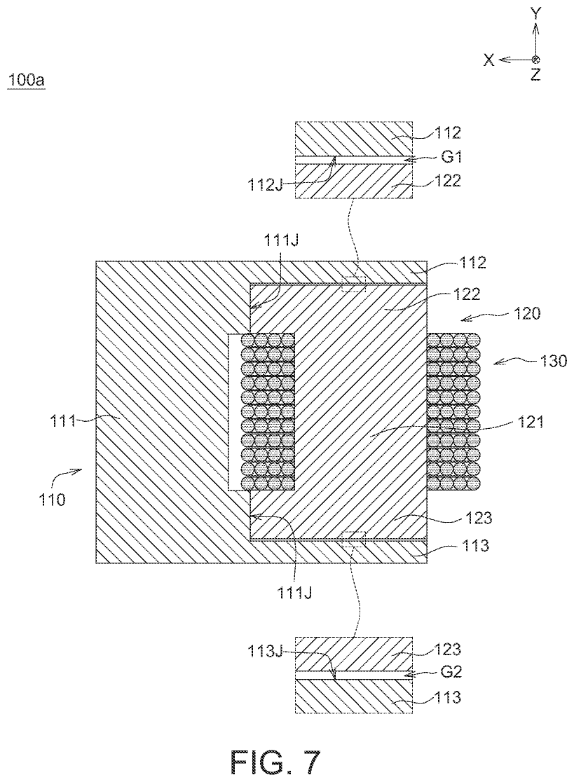

Besides, a third air gap G3 is formed between the first end post 122 of the second magnetic core 120 and the first joint surface 111J of the first side pillar 111 of the first magnetic core 110 and is interconnected with the first air gap G1; a fourth air gap G4 is formed between the second end post 123 of the second magnetic core 120 and the first joint surface 111J of the first side pillar 111 of the first magnetic core 110 and is interconnected with the second air gap G2. The third air gap G3 and the fourth air gap G4 are the distance between the first end post 122 and the first joint surface 111J and the distance between the second end post 123 and the first joint surface 111J on the X axis, respectively. The size of the third air gap G3 and the size of the fourth air gap G4 can be adjusted to achieve a desired amount of inductance. For instance, the size of the third air gap G3 and the size of the fourth air gap G4 can be adjusted from 0, that is, the first end post 122 and the second end post 123 can be attached on the first joint surface 111J, as indicated in FIG. 7, a cross-sectional view of a magnetic element 100a according to another embodiment of the present invention is shown. To adjust the initial inductance at a light load and delay the attenuation of inductance at a high load, the third air gap G3 and/or the fourth air gap G4 can be increased. The size of the third air gap G3 and the size of the fourth air gap G4 can be adjusted by moving the second magnetic core 120 along the X axis.

The first air gap G1, the second air gap G2, the third air gap G3 and the fourth air gap G4 can be respectively filled with an insulating adhesive layer (not illustrated), doped with insulating beads corresponding to the sizes of the first air gap G1, the second air gap G2, the third air gap G3 and the fourth air gap G4, so that the first magnetic core 110 and the second magnetic core 120 can be fixed through air gaps with suitable size.

Refer to FIG. 6 and FIG. 7. Since the surface by which the first end post 122 and the second end post 123 face the first air gap G1 and the second air gap G2 is flat, the first air gap G1 and the second air gap G2 are consistent in terms of size on the X axis and the Z axis. However, the present invention is not limited thereto. In other embodiments, the first air gap G1 and/or the second air gap G2 can vary in terms of size on the Z axis.

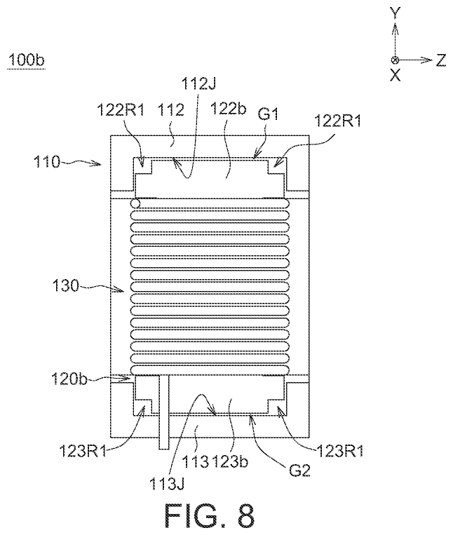

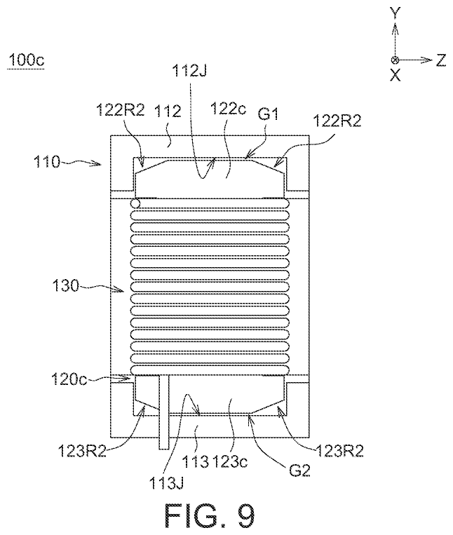

FIG. 8 is a side view of a magnetic element 100b according to an alternative embodiment of the present invention. FIG. 9 is a side view of a magnetic element 100c according to another alternative embodiment of the present invention.

Refer to FIG. 8. The magnetic element 100b of FIG. 8 is different from the magnetic elements 100 and 100a of FIG. 6 and FIG. 7 mainly in that in the present embodiment, the first end post 122b of the second magnetic core 120b has a notch 122R1 on the edge of the side closer to the second joint surface 112; the notch 122R1 penetrates the first end post 122b along the X axis. The second end post 123b of the second magnetic core 120b has a notch 123R1 on the edge of the side closer to the third joint surface 113J; the notch 123R1 penetrates the second end post 123b along the X axis. The notch 122R1 and the notch 123R1 respectively can be a cuboid notch, so that the first air gap G1 and the second air gap G2 form a step-like shape on the Z axis.

Refer to FIG. 9. The magnetic element 100c of FIG. 9 is different from the magnetic elements 100 and 100a of FIG. 6 and FIG. 7 mainly in that in the present embodiment, the first end post 122c of the second magnetic core 120c has a notch 122R2 on the edge of the side closer to the second joint surface 112J; the notch 122R2 penetrates the first end post 122c along the X axis. The second end post 123c of the second magnetic core 120c has a notch 123R2 on the edge of the side closer to the third joint surface 113J; the notch 123R2 penetrates the second end post 123c along the X axis. The notch 122R2 and the notch 123R2 can have the shape of a triangular prism, so that the first air gap G1 and the second air gap G2 gradually swell on two opposite sides on the Z axis.

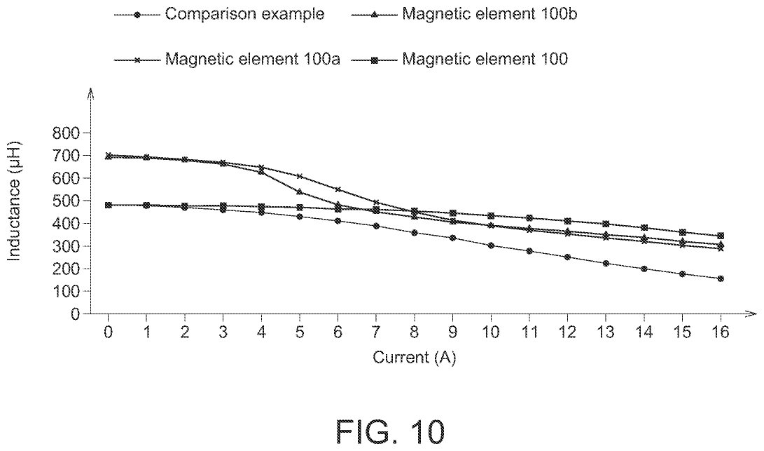

FIG. 10 is a diagram of inductance curves of a magnetic element of a comparison example and magnetic elements 100, 100a, 100b of embodiments of the present invention obtained under different loads of current. In the comparison example, the magnetic element has circular magnetic core. Some data are shown in Table 1.

| | Number | Initial inductance | DC resistance |
|---|---|---|---|
| | of coils | (μH) | (Mohm) |
| Comparison | 79 | 470 | 90.2 |
| example | | | |
| Magnetic element | 70 | 701 | 89.6 |
| 100a | | | |
| Magnetic element | 70 | 481 | 89.6 |
| 100 | | | |
| Magnetic element | 70 | 694 | 89.6 |
| 100b | | | |

Refer to FIG. 10 and Table 1. In comparison to the magnetic element of the comparison example, the magnetic element 100a can be formed with fewer coils and the overall amount of inductance is increased. In comparison to the magnetic element 100a whose third air gap G3 and fourth air gap G4 both are equivalent to 0, the third air gap G3 and the fourth air gap G4 of the magnetic element 100 are enlarged, so that the initial inductance at a light load can be adjusted and the attenuation of the inductance at a high load can be delayed. In comparison to the first air gap G1 and the second air gap G2 of the magnetic element 100a, the first air gap G1 and the second air gap G2 of the magnetic element 100b form a step-like shape on the Z axis, so that the inductance curve can be fine-tuned. Even when the load is heavy (for instance, the current is greater than 9A), the magnetic elements 100, 100a, and 100b of the embodiments of the present invention still can reduce the attenuation of the inductance and enhance overall current resistance.

Refer to FIG. 6. Since the surface by which the first end post 122 and the second end post 123 face the third air gap G3 and the fourth air gap G4 is flat, the third air gap G3 and the fourth air gap G4 are consistent in terms of size on the Y axis and the Z axis. However, the present invention is not limited thereto. In other embodiments, the third air gap G3 and/or the fourth air gap G4 can vary in terms of size on the Z axis.

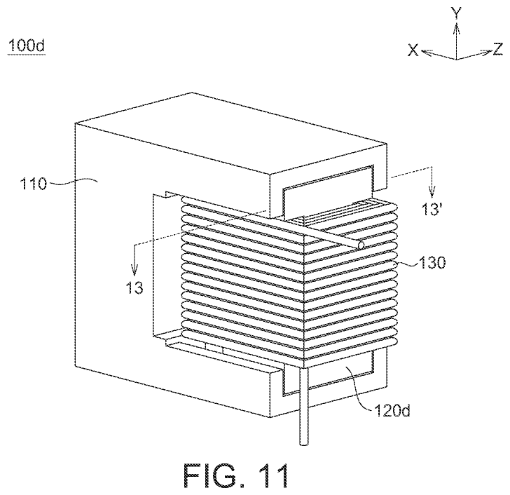

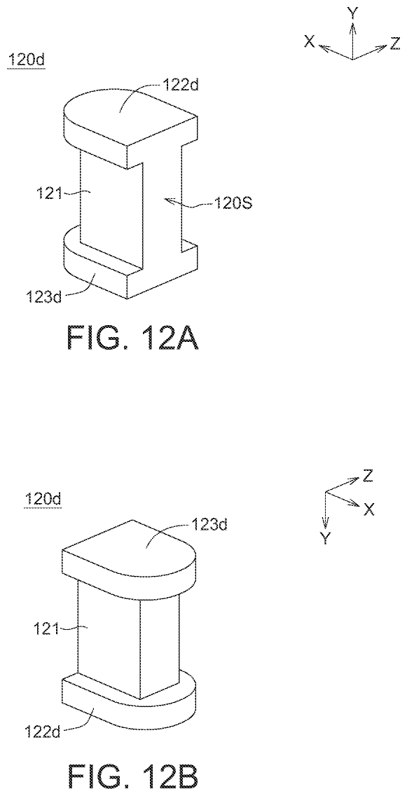

FIG. 11 is an assembly diagram of a magnetic element 100d according to other embodiment of the present invention. FIG. 12A is a schematic diagram of a second magnetic core 120d of the magnetic element 100 of FIG. 11. FIG. 12B is a schematic diagram of the second magnetic core 120d of FIG. 12A viewed from another view angle.

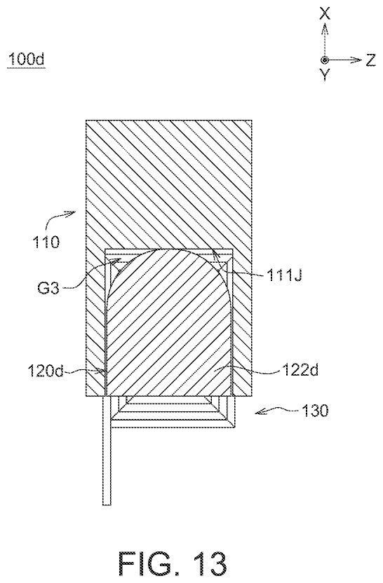

Refer to FIG. 11, FIG. 12A, FIG. 12B and FIG. 13. The magnetic element 100d is different from the magnetic elements 100 and 100a of FIG. 6 and FIG. 7 mainly in that the shape of the second magnetic core 120d is different from that of the second magnetic core 120. In the embodiment indicated in FIG. 6 and FIG. 7, the first end post 122 and the second end post 123 of the second magnetic core 120 respectively have a square flat structure. In the present embodiment, the first end post 122d and the second end post 123d of the second magnetic core 120d respectively have an arc structure, particularly on the side facing a positive direction of the X axis (or close to the first joint surface 111J. The arc structure is protruded toward the first joint surface 111J, so that the third air gap G3 and the fourth air gap (not illustrated) gradually swell on two opposite sides of the Z axis.

In an embodiment, as indicated in FIG. 13, the first end post 122d and the first joint surface 111J can have contact at the vertex of the arc structure and can be separated apart on two opposite sides farther away from the vertex, so that the third air gap G3 gradually swells from the center to two sides of the arc structure on the Z axis. Although it is not illustrated in the figure, the second end post 123d and the first joint surface 111J can have contact at the vertex of the arc structure and can be separated apart on two opposite sides farther away from the vertex, so that the fourth air gap gradually swells from the center to two sides of the arc structure on the Z axis. However, the present invention is not limited thereto. In another embodiment, the first end post 122d and the second end post 123d do not contact the first joint surface 111J.

To summarize, in the present invention, several air gaps are formed between the first magnetic core and the second magnetic core of the magnetic element for adjusting the efficiency of the magnetic element according to design needs. For instance, by adjusting the sizes and/or shapes of the air gaps, the current resistance of the magnetic element can be adjusted to be corresponding to the inductance at a light load, so that the efficiency can be optimized.

The above embodiments of the application only disclose some examples and implementations. However, based on the disclosed contents, modifications, adjustments, and improvements can be made to the above examples, implementations, and other possible implementations.

While the invention has been described by way of example and in terms of the preferred embodiment(s), it is to be understood that the invention is not limited thereto. Based on the technical features embodiments of the present invention, a person ordinarily skilled in the art will be able to make various modifications and similar arrangements and procedures without breaching the spirit and scope of protection of the invention. Therefore, the scope of protection of the present invention should be accorded with what is defined in the appended claims.

What is claimed is:

1. A magnetic element comprising:
a first magnetic core comprising a first flank post, a second flank post and a first side pillar, wherein the first side pillar has a first joint surface on which the first flank post and the second flank post are disposed; the first flank post, the second flank post and the first side pillar form an accommodation space; the first flank post and the second flank post have a second joint surface and a third joint surface, respectively, in a face-to-face configuration;
a second magnetic core disposed in the accommodation space, wherein the second magnetic core comprises a second side pillar, a first end post and a second end post; the first end post and the second end post are disposed at two ends of the second side pillar, respectively; a first air gap is formed between the first end post and the second joint surface, a second air gap is formed between the second end post and the third joint surface, a third air gap is formed between the first end post and the first joint surface, and a fourth air gap is formed between the second end post and the first joint surface; and
a coil set surrounding the second side pillar.

2. The magnetic element according to claim 1, wherein the first magnetic core is a U-shaped magnetic core; the second magnetic core is an I-shaped magnetic core.

3. The magnetic element according to claim 1, wherein the first side pillar of the first magnetic core has a groove portion recessed inwardly from the first joint surface.

4. The magnetic element according to claim 1, wherein the size of the third air gap and the fourth air gap is adjustable to achieve a desired amount of inductance.

5. The magnetic element according to claim 1, wherein the first end post and the first joint surface are separated on a first axis and form the third air gap; the second end post and the first joint surface are separated on the first axis and form the fourth air gap; the first end post and the second joint surface are separated on a second axis and form the first air gap; the second end post and the third joint surface are separated on the second axis and form the second air gap; the first axis is perpendicular to the second axis.

6. The magnetic element according to claim 5, wherein the first air gap is interconnected with the third air gap; the second air gap is interconnected with the fourth air gap.

7. The magnetic element according to claim 5, wherein at least one of the first air gap and the second air gap has an identical size on a third axis perpendicular to the first axis and the second axis.

8. The magnetic element according to claim 5, wherein at least one of the first air gap and the second air gap has a variable size on a third axis perpendicular to the first axis and the second axis.

9. The magnetic element according to claim 8, wherein the first end post has a notch, penetrating along the first axis, on an edge closer to the second joint surface, and/or the second end post has a notch, penetrating along the first axis, on an edge closer to the third joint surface.

10. The magnetic element according to claim 5, wherein at least one of the third air gap and the fourth air gap has an identical size on a third axis perpendicular to the first axis and the second axis.

11. The magnetic element according to claim 5, wherein at least one of the third air gap and the fourth air gap has a variable size on a third axis perpendicular to the first axis and the second axis.

12. The magnetic element according to claim 11, wherein the first end post has an arc structure protruded towards the first joint surface, and/or the second end post has an arc structure protruded towards the first joint surface.

13. The magnetic element according to claim 1, wherein the first joint surface has a first normal line, the second joint surface has a second normal line, and the third joint surface has a third normal line; the second normal line and the third normal line are orthogonal with the first normal line, the first normal line is parallel to a first axis, and the second normal line and the third normal line are parallel to a second axis.

14. The magnetic element according to claim 13, wherein the first end post and the second end post are respectively disposed on two ends of the second side pillar on the second axis.

15. The magnetic element according to claim 13, wherein each of the first flank post and the second flank post comprises a connection wall, a first wall and a second wall; the connection wall connects the first wall and the second wall, which are opposite to each other on a third axis perpendicular to the first axis and the second axis; the first wall, the connection wall and the second wall form a U-shaped flank post, the second joint surface is a surface by which the connection wall of the first flank post faces the accommodation space, and the third joint surface is a surface by which the connection wall of the second flank post faces the accommodation space.

16. The magnetic element according to claim 13, wherein the second magnetic core has a flat surface on a side farther away from the first joint surface of the first side pillar on the first axis, and the coil set feeds in and starts winding via one side of the flat surface.
